(19) United States
(12) Patent Application Publication
(10) Pub. No.: US 2017/0332599 A1
(43) Pub. Date: Nov. 23, 2017

(54) GAME FEEDER

(71) Applicant: BROW INCORPORATED, Sault Ste. Marie, MI (US)

(72) Inventor: Eric W. BROW, Sault Ste. Marie, MI (US)

(73) Assignee: BROW INCORPORATED, Sault Ste. Marie, MI (US)

(21) Appl. No.: 15/525,048

(22) PCT Filed: Nov. 5, 2015
(86) PCT No.: PCT/US15/00127

§ 371 Date: May 5, 2017

Related U.S. Application Data
(60) Provisional application No. 62/076,217, filed on Nov. 6, 2014.

(51) Int. Cl. A01K 5/02

(52) U.S. Cl. CPC A01K 5/0208; A01K 5/0225

(57) ABSTRACT

A game feeder especially suited to feeding whole vegetable roots and fruits. The game feeder includes: (a) a hopper having a first aperture at the bottom thereof, a second aperture 5 on one side thereof and a mouth at the top thereof; (b) a closure to close the mouth of the hopper; (c) a chute attached to or integral with the hopper, the chute having a receiving aperture aligned with the second aperture of the hopper, the chute having a discharge aperture at the bottom of the chute: (d) a conveyor belt positioned below the first aperture of the hopper so that when game feed is placed in the hopper and the conveyor belt is moved toward the second aperture. the game feed is conveyed to the chute so that the game feed can fall through the chute from the discharge aperture at the bottom of the chute. In an alternative embodiment, a swinging door located at the second aperture of the hopper is used in place of the chute.

### BACKGROUND OF THE INVENTION

The instant invention relates to automatic game feeders of the type used, for example, by deer hunters. The hunting industry has developed many sorts of feeders to attract wild animals. Typically, such feeders are placed near an area where the targeted animals travel, and dispense food on a regular schedule. They are often powered by batteries and/or solar panels, and controlled with timers. The most common devices (such as the device disclosed in U.S. Patent Application Publication 2014/01163343) hold feed pellets or bulk grain in an elevated hopper having a controllable opening at the bottom of the hopper and a rotating spreader to broadcast the feed pellets or grain onto the ground. A controller is typically part of the system that opens the controllable opening on a preset schedule.

Traditional broadcast feeders are limited in the type of feed they can dispense, i.e., traditional broadcast feeders are limited to dispensing feed pellets or corn. Traditional broadcast feeders are not suited to dispensing larger feed shapes such as vegetable roots (such as carrots or sugar beets) or fruit (such as apples). Larger feed is desired when hunting deer because larger feed is less attractive to other wild animals. Feeders that dispense such larger feed shapes using feed tubes and sharpened auger flights (such as the device disclosed in U.S. Pat. No. 8,800,489) are an advance in the art but tend to jam in cold weather when the feed is frozen and the sharpened auger flights are not able to cut the feed. It would be an advance in the art if a feeder were discovered that overcame the problems of conventional feeders especially when the feed comprises whole vegetable roots and fruits.

### SUMMARY OF THE INVENTION

The instant invention is a solution to the above mentioned problems with conventional feeders especially when the feed comprises whole vegetable roots and fruits. More specifically. the instant invention is a game feeder especially suited to feeding whole vegetable roots and fruits, comprising: (a) a hopper having a first aperture at the bottom thereof, a second aperture on one side thereof and a mouth at the top thereof; (b) a closure to close the mouth of the hopper; (c) a chute attached to or integral with the hopper, the chute having a receiving aperture aligned with the second aperture of the hopper, the chute having a discharge aperture at the bottom of the chute: (d) a conveyor belt positioned below the first aperture of the hopper so that when game feed is placed in the hopper and the conveyor belt is moved toward the second aperture, the game feed is conveyed to the chute so that the game feed can fall through the chute from the discharge aperture at the bottom of the chute.

In another embodiment, the instant invention is a game feeder especially suited to feeding whole vegetable roots and fruits, comprising: (a) a hopper having a first aperture at the bottom thereof, a second aperture on one side thereof and a mouth at the top thereof; (b) a closure to close the mouth of the hopper; (c) a door hingeably attached to the hopper at the upper edge of the second aperture of the hopper; (d) a conveyor belt positioned below the first aperture of the hopper so that when game feed is placed in the hopper and the conveyor belt is moved toward the second aperture, the game feed opens the door and falls from the hopper.

### BRIEF DESCRIPTION OF THE DRAWINGS

FIG. 1 is a side view of a highly preferred feeder of the instant invention;

FIG. 2 is a top view of the feeder shown in FIG. 1 with the lid thereof removed;

FIG. 3 is an end view of the left end of the feeder shown in FIG. 1;

FIG. 4 is an end view of the right end of the feeder shown in FIG. 1;

FIG. 5 is a side view of the conveyor belt and chute of the feeder shown in FIG. 1;

FIG. 6 is a side view of an alternative embodiment of the instant invention;

FIG. 7 depicts remote control of a feeder of the instant invention;

FIG. 8 shows the feeder of FIG. 1 mounted above the ground on a stand; and

FIG. 9 shows the feeder of FIG. 1 suspended above the ground from a tripod stand.

### DETAILED DESCRIPTION

The instant invention is a game feeder especially suited to feeding whole vegetable roots (such as carrots and sugar beets) or fruit (such as apples). FIG. 1 is a side view of a highly preferred feeder 10 of the instant invention comprising a hopper 11, a hopper closure in the form of lid 13, and a base 12. Lid 13 closes the mouth of hopper 11 and is preferably latched to hopper 11. Base 12 encloses a conveyor belt 19 and conveyor belt rollers 20, 21 to be described below. Hopper 11 has an aperture in the bottom thereof exposed to the conveyor belt 19. Chute 14 is attached to hopper 11 and base 12. The right side of the hopper 11 has an aperture aligned with a corresponding aperture in chute 14. The bottom of chute 14 is open, having a discharge aperture at the bottom of chute 14. FIG. 2 is a top view of the feeder 10 shown in FIG. 1 with the lid 13 thereof removed showing hopper 11, chute 14 and conveyor belt 19. FIG. 3 is an end view of the left end of the feeder 10 shown in FIG. 1 showing hopper 11, lid 13, base 12 and chute 14. FIG. 4 is an end view of the right end of the feeder 10 showing hopper 11, lid 13 and chute 14.

Referring now to FIG. 5, therein is shown a side view of conveyor belt 19, conveyor belt drive roller 20, conveyor belt idler roller 21, and chute 14 of the feeder 10 shown in FIG. 1. The ends of the shafts of conveyor belt rollers 21 and 22 are mounted in bearings attached to the base 12 of the feeder 10. Referring for the moment back to FIG. 1, the shaft of the conveyor belt drive roller 20 is driven by electric motor 15 by way of worm drive 18. Referring again to FIG. 5, when conveyor belt 19 is driven in the direction shown by the arrows, game feed 22 is conveyed into chute 14 so that the game feed 22 can fall through the chute 14 from the discharge aperture at the bottom of chute 14. It should be understood that the chute 14 of this embodiment of the instant invention can be a separate element attached to hopper 11 or can be formed integrally with the hopper 11. Since it is preferable to make the hopper 11 and the chute 14 from sheet metal stock, they are probably more conveniently made separately and then joined together.

Referring now to FIG. 6, therein is shown another embodiment of the instant invention employing a door 31 hingeably attached by hinge 31a to the hopper 11 at the upper edge of the second aperture of the hopper 11. When game feed 22 is placed on conveyor belt 19 and the conveyor belt 19 is moved in the direction of the arrows, the game feed 22 opens the door 31 and the game feed 22 falls from the feeder 10. A door interlock is preferably used to latch the door 31 closed when conveyor belt 19 is not being driven so that small animals such a raccoons cannot reach into the hopper 11 at such times.

Referring again to FIG. 1, a battery 17 and an electric-motor controller 16 are shown attached to base 12. The output shaft of electric motor 15 is in mechanical communication with the conveyor belt drive roller 20 by way of worm drive 18. Battery 17 and electric-motor controller 16 are in electrical communication with the electric motor 15 so that the electric motor 15 can be run in a controlled manner. The specific manner of control is not critical in the instant invention, and, for example, may comprise either a time schedule programmed into the electric-motor controller 16, or external signals 24 to the electric-motor controller 16 from a remote source 23.

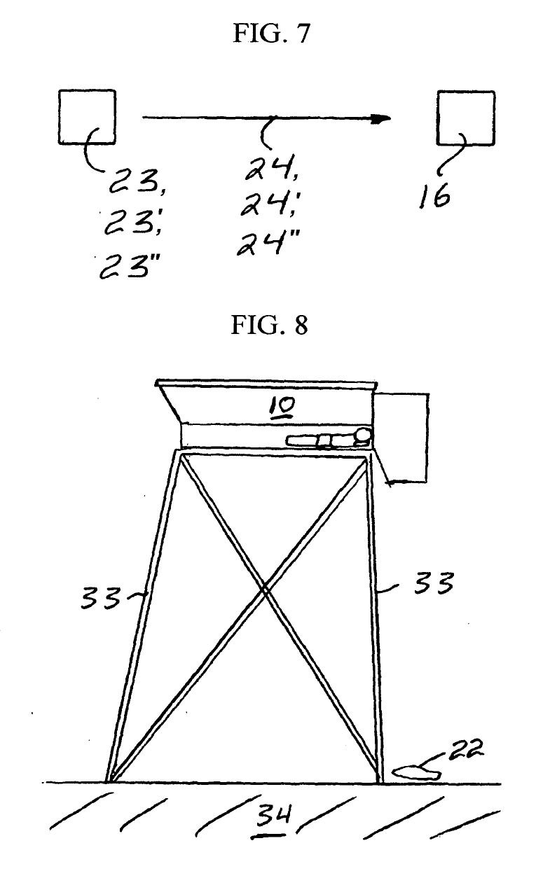

Referring now to FIG. 7, therein is shown electric-motor controller 16 receiving signals 24 from remote source 23. If remote source 23 is a light transmitter 23′ (such as television remote control infrared light transmitter 23′) then the electric-motor controller 16 would be provided with a light receiver to receive a light signal 24′ from the light transmitter 23′. If the remote source 23 is a radio transmitter 23″, then the electric-motor controller 16 would be provided with a radio receiver to receive the radio signal 24″ from the radio transmitter 23″, wherein such radio signal 24″ could even originate from a cellular telephone transmission tower by way of an application embedded in a smartphone. Remote control of the feeder 10 of the instant invention is especially beneficial when it is desired to dispense game feed 22 only when the hunter is located in position to hunt near the feeder 10. The hunter can take a concealed position, dispense game feed 22 and then wait for game (such as a deer) to be attracted to the game feed 22.

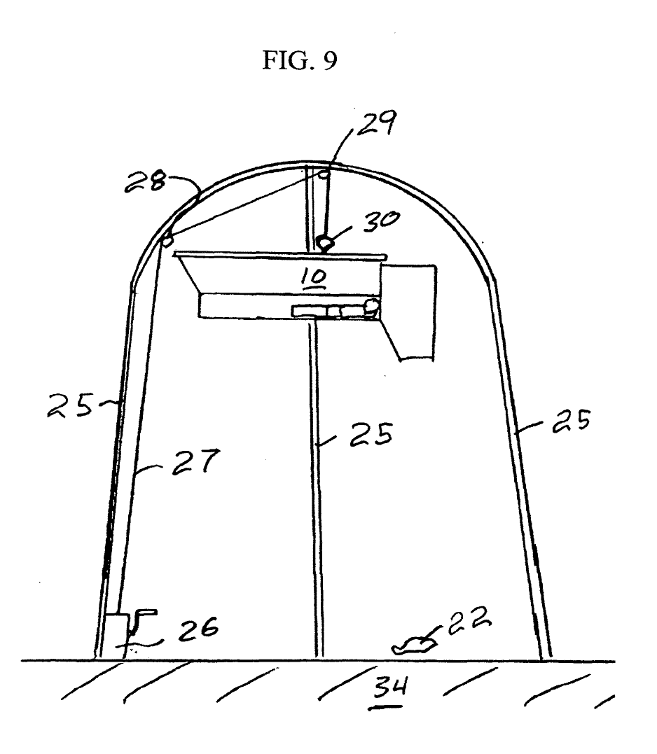

Referring now to FIG. 8, therein is shown a side view of feeder 10 of FIG. 1 positioned above the ground 34 on a stand 33. Referring now to FIG. 9, therein is shown a side view of feeder 10 of FIG. 1 suspended above the ground 34 from a rope or wire 27 routed through pulleys 28 and 29 suspended from a tripod stand 25, with one end of the rope or wire 27 attached to a winch 26 and at the other end of the rope or wire 27 attached to a hoisting eye 30 that is operatively coupled to the feeder 10. The embodiment shown in FIG. 9 has the important benefit of permitting the feeder 10 to be lowered to fill the hopper 11 thereof, thereby avoiding the need to carry game feed 22 up to the feeder 10.

While the instant invention has been described above and exemplified below according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains. For example, the hopper 11, base 12 and lid 13 can be of any suitable material such as aluminum or other metal or a plastic material. The conveyor belt 19 and conveyor belt rollers 20, 21 can be made of any suitable material and are readily available. The conveyor belt 19/electric motor 15 drive system can be worm geared, spur geared, sun geared, direct drive or any other suitable drive system and are readily available. And any suitable electric-motor controller 16 can be used including the readily available controllers described above and the controller exemplified below. The feeder 10 can also have a bracket for attachment of a game camera. The battery 17 of the instant invention can be any suitable battery and can be connected to a solar battery charger. The hopper 11 can be vented so that the scent of game feed 22 in the hopper 11 of the feeder 10 permeates the area surrounding the feeder 10. Although the game feed 22 used in the feeder 10 of the instant invention can be pellet feed and/or grain, the feeder 10 of the instant invention is especially suited to feeding whole vegetable roots and/or whole fruit. Finally, the specifics of the feeder 10 of the following example are only to exemplify one preferred embodiment of the instant invention.

### EXAMPLE

The base 12, hopper 11, lid 13 and chute 14 of the feeder 10 shown in FIG. 1 are assembled by seam welding sheet steel stock. The chute 14 is welded to the hopper 11 and base 12. The lid 13 is hinged to the hopper 11 and provided with a latch to latch the lid 13 to the hopper 11. The steel surfaces of the feeder 10 are powder coated to inhibit rusting. The hopper 11 is filled with carrots, sugar beets and apples as a deer specific feed. The mouth of the hopper 11 is 92 centimeters cm by 36 centimeters. The base 12 is 76 centimeters by 52 centimeters. The hopper 11 is 36 centimeters high. The discharge aperture of the chute 14 is 36 centimeters by 52 centimeters. The chute 14 is 85 centimeters in height and closed at the top and exposed sides. A 50 centimeter wide rubber conveyor belt 19 and associated conveyor belt rollers 20, 21 are positioned in the base 12 by way of bearing mounts in the base 12 so that the conveyor belt 19 is exposed to the bottom aperture of the hopper 11, The conveyor belt drive roller 20 is connected to the output shaft of a commercially available, worm drive output, 6 volt electric motor by way of the associated worm drive output shaft. An electric-motor controller 16 and battery 17 are attached to the base 12. The battery 17 is a 6 volt sealed lead acid battery. The electric-motor controller 16 is salvaged from a radio controlled toy car so that when the controller receives a go forward signal from the radio transmitter 23″ for the radio controlled toy car the, electric-motor controller 16 energizes the electric motor 15 to drive the conveyor belt 19 in a direction towards the chute 14 to dispense game feed 22 from the feeder 10 to fall to the ground 34.

1. A game feeder especially suited to feeding whole vegetable roots and/or whole fruits, comprising:
a hopper having a first aperture at the bottom thereof, a second aperture on one side thereof and a mouth at the top thereof;
a closure to close the mouth of the hopper;
a chute attached to or integral with the hopper, the chute having a receiving aperture aligned with the second aperture of the hopper, the chute having a discharge aperture at the bottom of the chute; and
a conveyor belt positioned below the first aperture of the hopper so that when game feed is placed in the hopper and the conveyor belt is moved toward the second aperture, the game feed is conveyed to the chute so that the game feed can fall through the chute from the discharge aperture at the bottom of the chute.

2. The game feeder of claim 1, further comprising a conveyor belt drive roller, a battery, an electric-motor controller, and an electric motor, the electric motor being in mechanical communication with the conveyor belt drive roller, the battery and the electric-motor controller being in electrical communication with the electric motor so that the electric motor can be run in a controlled manner.

3. The game feeder of claim 2, wherein the electric-motor controller is programmable to run the electric motor at selected times.

4. The game feeder of claim 2, wherein the electric-motor controller comprises a light receiver so that the electric motor can be run by directing light at the light receiver.

5. The game feeder of claim 2, wherein the electric-motor controller comprises a radio receiver so that the electric motor can be run responsive to radio transmission.

6. The game feeder of claim 5, wherein the radio transmission originates from a cellular telephone transmission tower.

7. A game feeder especially suited to feeding whole vegetable roots and/or whole fruits, comprising:
a hopper having a first aperture at the bottom thereof, a second aperture on one side thereof and a mouth at the top thereof;
a closure to close the mouth of the hopper;
a door hingeably attached to the hopper at the upper edge of the second aperture of the hopper; and
a conveyor belt positioned below the first aperture of the hopper so that when game feed is placed in the hopper and the conveyor belt is moved toward the second aperture, the game feed opens the door and falls from the hopper.

8. The game feeder of claim 7 further comprising a conveyor belt drive roller, a battery, an electric motor controller, and an electric motor, the electric motor being in mechanical communication with the conveyor belt drive roller, the battery and the electric-motor controller being in electrical communication with the electric motor so that the electric motor can be run in a controlled manner.

9. The game feeder of claim 8, wherein the electric-motor controller is programmable to run the electric motor at selected times.

10. The game feeder of claim 8, wherein the electric-motor controller comprises a light receiver so that the electric motor can be run by directing light at the light receiver.

11. The game feeder of claim 8, wherein the electric-motor controller comprises a radio receiver so that the electric motor can be run responsive to radio transmission.

12. The game feeder of claim 511, wherein the radio transmission originates from a cellular telephone transmission tower.

13. A method of dispensing whole vegetable roots and/or whole fruits as animal feed, comprising:
a. loading a hopper of an animal feeder with the whole vegetable roots and/or whole fruits, wherein said animal feeder comprises:
i. said hopper, wherein said hopper comprises:
a) a first aperture at a bottom of said hopper;
b) a second aperture on one side of said hopper; and
c) a mouth at a top of said hopper; and
ii. a conveyor belt positioned below said first aperture of said hopper so that when said whole vegetable roots and/or whole fruits is/are placed in said hopper, a top surface of said conveyor belt receives at least a portion of said whole vegetable roots and/or whole fruits from said hopper, and when said top surface of said conveyor belt is driven towards said second aperture, at least a portion of said portion of said whole vegetable roots and/or whole fruits is conveyed through said second aperture and then discharged to a location from which an animal can feed, wherein said conveyor belt is driven by a battery-powered electric motor under control of an electric-motor controller; and
b. at least one of a) pre-programming said electric-motor controller or b) remotely controlling said electric-motor controller, so as to cause said battery-powered electric motor to drive said top surface of said conveyor belt towards said second aperture at at least one selected time for a corresponding at least one selected duration.

14. A method of dispensing whole vegetable roots and/or whole fruits as animal feed controlling said in claim 13, wherein said animal feeder further comprises a chute either attached to or integral with said hopper, wherein said chute provides for both
a. receiving said whole vegetable roots and/or whole fruits from said second aperture of said hopper, and
b. directing said whole vegetable roots and/or whole fruits received therefrom to said location from which said animal can feed.

15. A method of dispensing whole vegetable roots and/or whole fruits as animal feed as recited in claim 13, wherein said animal feeder further comprises a door hingeably attached to said hopper so as to provide for closing said second aperture to access from outside of said hopper, while also providing for said whole vegetable roots and/or whole fruits dispensed by said conveyor belt to open said door away from said hopper and then dispense said portion of said portion of said whole vegetable roots and/or whole fruits onto said location from which said animal can feed.

16. A method of dispensing whole vegetable roots and/or whole fruits as animal feed as recited in claim 13, wherein said animal feeder further comprises a removable or openable closure that provides for closing said mouth of said hopper, and when removed or opened, provides for loading said hopper with said whole vegetable roots and/or whole fruits.

17. A method of dispensing whole vegetable roots and/or whole fruits as animal feed as recited in claim 13, wherein said location from which said animal can feed comprises the ground.

18. A method of dispensing whole vegetable roots and/or whole fruits as animal feed as recited in claim 13, wherein during operation of said animal feeder to dispense said whole vegetable roots and/or whole fruits, said animal feeder is suspended from an elevated location that is relatively elevated relative to said location from which said animal can feed, further comprising mechanically lowering said animal feeder from said elevated location to load said hopper with said whole vegetable roots and/or whole fruits.

19. A method of dispensing whole vegetable roots and/or whole fruits as animal feed as recited in claim 13, further comprising programming said electric-motor controller to dispense said whole vegetable roots and/or whole fruits at at least one predetermined time for a corresponding at least one predetermined period of time.

20. A method of dispensing whole vegetable roots and/or whole fruits as animal feed as recited in claim 13, further comprising remotely controlling the operation of said battery-powered electric motor responsive to either a light signal or a radio signal transmitted to said electric-motor controller.

21. A method of dispensing whole vegetable roots and/or whole fruits as animal feed as recited in claim 13, wherein said animal comprises a wild-game animal, and said animal feeder is located in a wild environment.

22. A method of dispensing whole vegetable roots and/or whole fruits as wild-game-animal feed, comprising using an electric-motor-driven conveyor of a wild-game-animal feeder to dispense the whole vegetable roots and/or whole fruits from a relatively elevated location to a relatively lower location from which a wild-game animal can feed, wherein said electric-motor-driven conveyor is under control of an electric-motor controller of said wild-game-animal feeder that at least one of a) is programmed to operate said electric-motor-driven conveyor at at least one predetermined time and for at least one corresponding predetermined interval of time or b) provides for operating said electric-motor-driven conveyor responsive to a remote-control signal, a hopper of said wild-game-animal feeder is located above said electric-motor-driven conveyor, a top surface of said electric-motor-driven conveyor is fed with said whole vegetable roots and/or whole fruits through a first aperture at a bottom of said hopper, and when dispensing said whole vegetable roots and/or whole fruits, said electric-motor-driven conveyor moves said top surface towards a second aperture in a side of said hopper so as to provide for said whole vegetable roots and/or whole fruits to pass therethrough and then fall onto said relatively lower location.

23. A method of dispensing whole vegetable roots and/or whole fruits as wild-game-animal feed as recited in claim 22, further comprising mechanically lowering said wild-game-animal feeder from said relatively elevated location to provide for loading said hopper with said whole vegetable roots and/or whole fruits.

24. A method of dispensing whole vegetable roots and/or whole fruits as wild-game-animal feed as recited in claim 22, wherein said remote-control signal comprises either a light signal or a radio signal transmitted to said electric-motor controller.

25. A method of dispensing whole vegetable roots and/or whole fruits as wild-game-animal feed as recited in claim 22, further comprising preventing access to said whole vegetable roots and/or whole fruits within said hopper by an animal when said electric-motor-driven conveyor is not in operation.
